(19) United States
(12) Patent Application Publication
(10) Pub. No.: US 2006/0177338 A1
(43) Pub. Date: Aug. 10, 2006

(54) Horizontal type orbiting vane compressor

(75) Inventors: Seon-woong Hwang, Anyang-Si (KR); Dong-won Yoo, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/208,721

(22) Filed: Aug. 23, 2005

(30) Foreign Application Priority Data
Feb. 4, 2005 (KR) 10-2005-0010694

(51) Int. Cl. F01C 20/18; F16N 13/20; F01C 1/02; F04C 2/00; F04C 14/18

(52) U.S. Cl. 418/59; 418/58; 418/30

(57) ABSTRACT

Disclosed herein is a horizontal type orbiting vane compressor having a horizontal structure. The horizontal type orbiting vane compressor comprises a horizontally disposed shell having an inlet tube and an outlet tube, a compression unit disposed in the shell at one side of a horizontally disposed rotary shaft such that the compression unit is rotated by a drive unit for compressing refrigerant gas, and an oil-supplying unit for supplying oil from an oil sump formed at the lower part of the shell to an oil hole extending through the rotary shaft by the discharge pressure of the compressed high-pressure refrigerant gas. When the horizontal type orbiting vane compressor is applied to an air conditioner, an outdoor unit of the air conditioner is miniaturized.

### BACKGROUND OF THE INVENTION

1. Field of the Invention

The present invention relates to an orbiting vane compressor that is capable of forming compression chambers at the inside and the outside of a wrap of an orbiting vane as the wrap performs an orbiting movement in an operation space defined in a cylinder, and, more particularly, to a horizontal type orbiting vane compressor having a horizontal structure.

2. Description of the Related Art

Generally, an orbiting vane compressor is constructed to compress refrigerant gas introduced into a cylinder through an orbiting movement of an orbiting vane in the cylinder having an inlet port. Various types of orbiting vane compressors, which are classified based on their shapes, have been proposed.

FIG. 1 is a longitudinal sectional view illustrating the overall structure of a conventional rotary-type orbiting vane compressor. As shown in FIG. 1, a drive unit D and a compression unit P, which is disposed below the drive unit D, are mounted in a shell 1 while the drive unit D and the compression unit P are hermetically sealed. The drive unit D and the compression unit P are connected to each other via a vertical rotary shaft 6, which has an eccentric part 6a.

The drive unit D comprises: a stator 2 fixedly disposed in the shell 1; and a rotor 3 disposed in the stator 2 for rotating the rotary shaft 6, which vertically extends through the rotor 3, when electric current is supplied to the rotor 3.

The compression unit P comprises an orbiting vane 4 for performing an orbiting movement in a cylinder 5 by the eccentric part 6a of the rotary shaft 6. As the orbiting vane 4 performs the orbiting movement in the cylinder 5, refrigerant gas introduced into the cylinder 5 through an inlet port 51 is compressed. The cylinder 5 has an inner ring 52. Between the inner ring 52 and the inner wall of the cylinder 5 is defined an annular operation space 53. A wrap 40 of the orbiting vane 4 performs an orbiting movement in the operation space 53. As a result, compression chambers are formed at the inside and the outside of the wrap 40, respectively.

At the upper and lower parts of the compression unit P are disposed a main bearing 7 and a subsidiary bearing 7a, which support opposite ends of the rotary shaft 6, respectively. The subsidiary bearing 7a has a discharge chamber 8a, which is defined by a muffler 8. The discharge chamber 8a is connected to a pipe-shaped discharge channel 9, which extends vertically through the compression unit P and the main bearing 7, such that the compressed refrigerant gas is discharged into the shell 1 through the discharge channel 9.

Unexplained reference numeral 11 indicates an inlet tube, 12 an outlet tube, and 10a an Oldham's ring for preventing rotation of the wrap 40 of the orbiting vane 4.

When electric current is supplied to the drive unit D, the rotor 3 of the drive unit D is rotated, and therefore, the rotary shaft 6, which vertically extends through the rotor 3, is also rotated. As the rotary shaft 6 is rotated, the orbiting vane 4 attached to the eccentric part 6a of the rotary shaft 6 performs an orbiting movement.

As a result, the wrap 40 of the orbiting vane 4 performs an orbiting movement in the operation space 53 of the cylinder 5 to compress refrigerant gas introduced into the cylinder 5 through the inlet port 51 in the compression chambers formed at the inside and the outside of the wrap 40, respectively. The compressed refrigerant gas is discharged into the discharge chamber 8a through inner and outer outlet ports (not shown) formed at the cylinder 5 and the subsidiary bearing 7a. The discharged high-pressure refrigerant gas is guided into the shell 1 through the discharge channel 9. Finally, the compressed refrigerant gas is discharged out of the shell 1 through the outlet tube 12.

FIG. 2 is a plan view, in section, illustrating the compressing operation of the conventional orbiting vane compressor shown in FIG. 1.

As shown in FIG. 2, the wrap 40 of the orbiting vane 4 of the compression unit P performs an orbiting movement in the operation space 53 of the cylinder 5, as indicated by arrows, to compress refrigerant gas introduced into the operation space 53 through the inlet port 51. The orbiting movement of the wrap 40 of the orbiting vane 4 will be described hereinafter in more detail.

At the initial orbiting position of the wrap 40 of the orbiting vane 4 of the compression unit P (i.e., the 0-degree orbiting position), refrigerant gas is introduced into an inner suction chamber A1, which is disposed at the inside of the wrap 40, through the inlet port 51, and compression is performed in an outer compression chamber B2, which is disposed at the outside of the wrap 40, while the outer compression chamber B2 does not communicate with the inlet port 51 and an outer outlet port 53b. Refrigerant gas is compressed in an inner compression chamber A2, and at the same time, the compressed refrigerant gas is discharged out of the inner compression chamber A2.

At the 90-degree orbiting position of the wrap 40 of the orbiting vane 4 of the compression unit P, the compression is still performed in the outer compression chamber B2, and almost all the compressed refrigerant gas is discharged out of the inner compression chamber A2 through an inner outlet port 53a. At this stage, an outer suction chamber B1 appears so that refrigerant gas is introduced into the outer suction chamber B1 through the inlet port 51.

At the 180-degree orbiting position of the wrap 40 of the orbiting vane 4 of the compression unit P, the inner suction chamber A1 disappears. Specifically, the inner suction chamber A1 is changed into the inner compression chamber A2, and therefore, compression is performed in the inner compression chamber A2. At this stage, the outer compression chamber B2 communicates with the outer outlet port 53b. Consequently, the compressed refrigerant gas is discharged out of the outer compression chamber B2 through the outer outlet port 53b.

At the 270-degree orbiting position of the wrap 40 of the orbiting vane 4 of the compression unit P, almost all the compressed refrigerant gas is discharged out of the outer compression chamber B2 through the outer outlet port 53b, and the compression is still performed in the inner compression chamber A2. Also, compression is newly performed in the outer suction chamber B1. When the orbiting vane 4 of the compression unit P further performs the orbiting movement by 90 degrees, the outer suction chamber B1 disappears. Specifically, the outer suction chamber B1 is changed into the outer compression chamber B2, and therefore, the compression is continuously performed in the outer compression chamber B2. As a result, the wrap 40 of the orbiting vane 4 of the compression unit P is returned to the position where the orbiting movement of the orbiting vane 4 is initiated. In this way, a 360-degree-per-cycle orbiting movement of the wrap 40 of the orbiting vane 4 of the compression unit P is accomplished. The orbiting movement of the wrap 40 of the orbiting vane 4 of the compression unit P is performed in a continuous fashion.

The conventional rotary-type orbiting vane compressor with the above-stated construction is a vertical type orbiting vane compressor, which is vertically installed. When the vertical type orbiting vane compressor is installed in an outdoor unit of an air conditioner, the size of the outdoor unit is relatively increased, since the vertical type orbiting vane compressor occupies a relatively large installation space in the outdoor unit, and therefore, miniaturization of the outdoor unit is very difficult. On the other hand, a horizontal type orbiting vane compressor is horizontally mounted below a cooling fan of the outdoor unit of the air conditioner, and therefore, miniaturization of the outdoor unit is easily accomplished. Consequently, demand for horizontal type orbiting vane compressors is increasing. However, serious consideration must be given to an oil-supplying structure of the horizontal type orbiting vane compressor when the horizontal type orbiting vane compressor is designed.

### SUMMARY OF THE INVENTION

Therefore, the present invention has been made in view of the above problems, and it is an object of the present invention to provide a horizontal type orbiting vane compressor that is capable of forming compression chambers at the inside and the outside of a wrap of an orbiting vane as the wrap performs an orbiting movement in an operation space defined in a cylinder.

It is another object of the present invention to provide a horizontal type orbiting vane compressor having an improved oil-supplying structure, thereby eliminating the problem in connection with oil supply and simplifying the structure of the orbiting vane compressor.

In accordance with the present invention, the above and other objects can be accomplished by the provision of a horizontal type orbiting vane compressor comprising: a horizontally disposed shell having an inlet tube and an outlet tube; a compression unit disposed in the shell at one side of a horizontally disposed rotary shaft such that the compression unit is rotated by a drive unit for compressing refrigerant gas, the compression unit including a cylinder having an inlet port formed at one side thereof, and a wrap of an orbiting vane for performing an orbiting movement in an operation space defined in the cylinder; and an oil-supplying unit for supplying oil from an oil sump formed at the lower part of the shell to an oil hole extending through the rotary shaft by the discharge pressure of the compressed high-pressure refrigerant gas.

Preferably, the horizontal type orbiting vane compressor further comprises: a muffler disposed adjacent to the outlet ports of the compression unit; and a discharge channel formed inside the muffler, the discharge channel extending though the compression unit.

Preferably, the oil-supplying unit comprises: a discharge pipe having one end horizontally connected to the lower part of the muffler and the other end bent upward such that the upward-bent end is perpendicular to the end of the discharge pipe horizontally connected to the lower part of the muffler; and an oil tube having one end communicating with the oil hole, which horizontally extends through the rotary shaft, and the other end bent downward such that the downward-bent end is perpendicular to the end of the oil tube communicating with the oil hole, the downward-bent end of the oil tube surrounding the upward-bent end of the discharge pipe.

Preferably, the oil-supplying unit further comprises: an oil inlet port formed between the oil tube and the discharge pipe.

Preferably, the oil-supplying unit further comprises: an oil separating plate disposed at the outlet side of the oil hole of the rotary shaft.

Preferably, the rotary shaft is disposed such that opposite ends of the rotary shaft are rotatably supported by a main bearing and a subsidiary bearing, which are disposed at opposite sides of the compression unit, respectively.

Preferably, the inlet port of the cylinder communicates with the inlet tube of the shell.

Preferably, the operation space is defined between an inner wall of the cylinder and an inner ring.

Preferably, the operation space is divided into inner and outer compression chambers by the wrap.

Preferably, the cylinder has a pair of outlet ports, which communicate with the inner and outer compression chambers, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view illustrating the overall structure of a conventional rotary-type orbiting vane compressor;

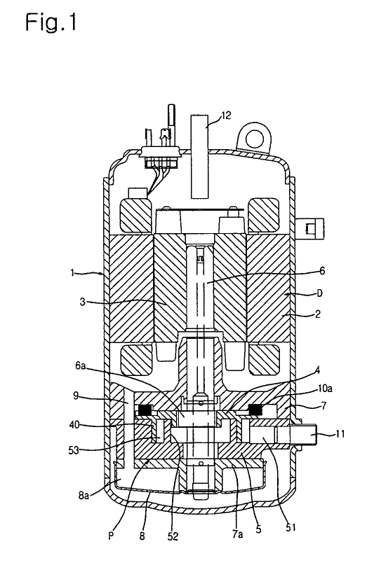

FIG. 2 is a plan view, in section, illustrating the compressing operation of the conventional orbiting vane compressor shown in FIG. 1;

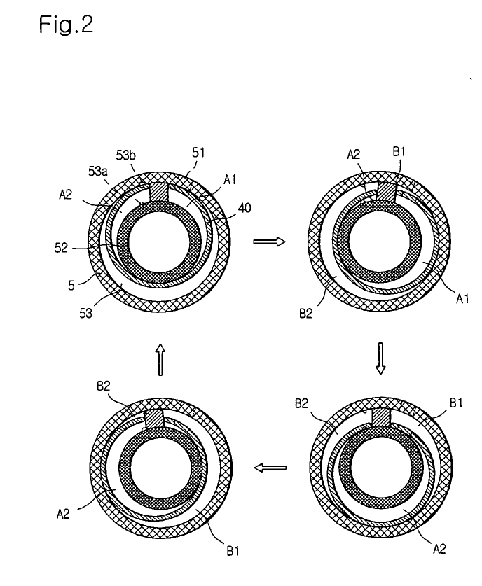

FIG. 3 is a longitudinal sectional view illustrating the overall structure of a horizontal type orbiting vane compressor according to the present invention;

FIG. 4 is an enlarged view, in section, illustrating the oil-supplying structure of the horizontal type orbiting vane compressor according to the present invention shown in FIG. 3;

FIG. 5A is a longitudinal sectional view illustrating oil supply when the operation of the horizontal type orbiting vane compressor is stopped; and

FIG. 5B is a longitudinal sectional view illustrating oil supply when the operation of the horizontal type orbiting vane compressor is initiated or resumed.

### DESCRIPTION OF THE PREFERRED EMBODIMENTS

Now, a preferred embodiment of the present invention will be described in detail with reference to the accompanying drawings.

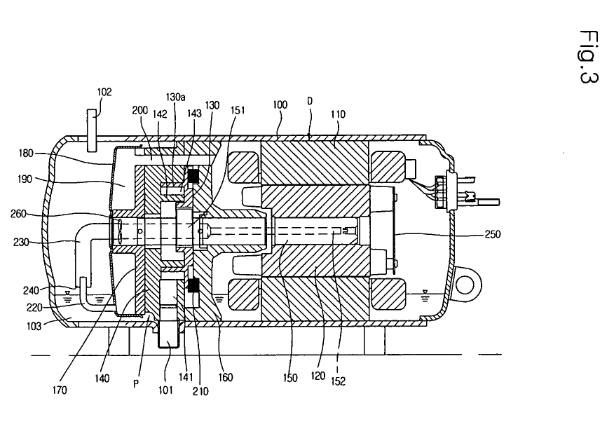

FIG. 3 is a longitudinal sectional view illustrating the overall structure of a horizontal type orbiting vane compressor according to the present invention. As shown in FIG. 3, the horizontal type orbiting vane compressor comprises: a hermetically sealed shell 100, which is horizontally disposed; a compression unit P disposed at one side in the shell 100; and a drive unit D disposed at the other side in the shell 100. The compression unit P and the drive unit D are connected to each other via a rotary shaft 150, which has an eccentric part 151.

The drive unit D comprises: a stator 110 fixedly disposed in the shell 100; and a rotor 120 disposed in the stator 110 for rotating the rotary shaft 150, which horizontally extends through the rotor 120, when electric current is supplied to the rotor 120.

The compression unit P comprises an orbiting vane 130 for performing an orbiting movement in a cylinder 140 by the eccentric part 151 of the rotary shaft 150. As the orbiting vane 130 performs the orbiting movement in the cylinder 140, refrigerant gas introduced into the cylinder 140 through an inlet port 141 is compressed. The cylinder 140 has an inner ring 142. Between the inner ring 142 and the inner wall of the cylinder 140 is defined an annular operation space 143. A wrap 130a of the orbiting vane 130 performs an orbiting movement in the operation space 143. As a result, compression chambers are formed at the inside and the outside of the wrap 130a, respectively.

At opposite sides of the compression unit P are disposed a main bearing 160 and a subsidiary bearing 170, which support opposite ends of the rotary shaft 150, respectively. The subsidiary bearing 170 has a discharge chamber 190, which is defined by a muffler 180. The discharge chamber 190 is connected to a pipe-shaped discharge channel 200, which extends horizontally through the compression unit P and the main bearing 160, such that the compressed refrigerant gas is discharged into the shell 1 through the discharge channel 200.

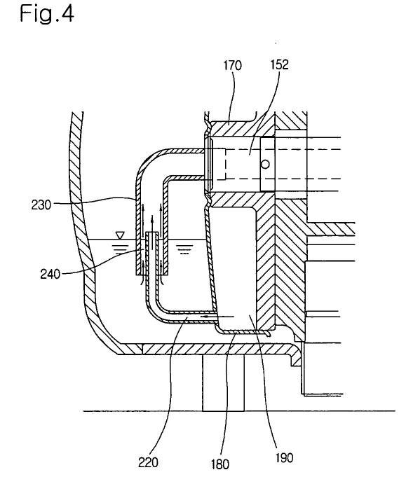

Below the muffler 180 is disposed an oil-supplying unit. As shown in FIG. 4, the oil-supplying unit comprises: a discharge pipe 220 having one end horizontally connected to the lower part of the muffler 180 such that the discharge pipe 220 communicates with the discharge chamber 190 defined by the muffler 180 and the other end bent upward such that the upward-bent end is perpendicular to the end of the discharge pipe 220 horizontally connected to the lower part of the muffler 180. Consequently, the pressure of the compressed refrigerant gas discharged from the discharge chamber 190 is applied to the discharge pipe 220. The oil-supplying unit further comprises: an oil tube 230 having one end communicating with an oil hole 152 horizontally extending through the rotary shaft 150 and the other end bent downward such that the downward-bent end is perpendicular to the end of the oil tube 230 communicating with the oil hole 152. The downward-bent end of the oil tube 230 surrounds the upward-bent end of the discharge pipe 220 such that an oil inlet port 240 is formed between the oil tube 230 and the discharge pipe 220.

Unexplained reference numeral 101 indicates an inlet tube, 102 an outlet tube, 210 an Oldham's ring for preventing rotation of the wrap 40 of the orbiting vane 4, and 250 an oil separating plate.

When electric current is supplied to the drive unit D, the rotor 120 of the drive unit D is rotated, and therefore, the rotary shaft 150, which horizontally extends through the rotor 120, is also rotated. As the rotary shaft 150 is rotated, the orbiting vane 130 attached to the eccentric part 151 of the rotary shaft 150 performs an orbiting movement.

As a result, the wrap 130a of the orbiting vane 130 performs an orbiting movement in the operation space 143 of the cylinder 140 to compress refrigerant gas introduced into the cylinder 140 through the inlet port 141 in the compression chambers formed at the inside and the outside of the wrap 130a, respectively. The compressed refrigerant gas is discharged into the discharge chamber 190 through inner and outer outlet ports (not shown) formed at the cylinder 140 and the subsidiary bearing 170. The discharged high-pressure refrigerant gas is guided into the shell 100 through the discharge channel 200. Finally, the compressed refrigerant gas is discharged out of the shell 100 through the outlet tube 102.

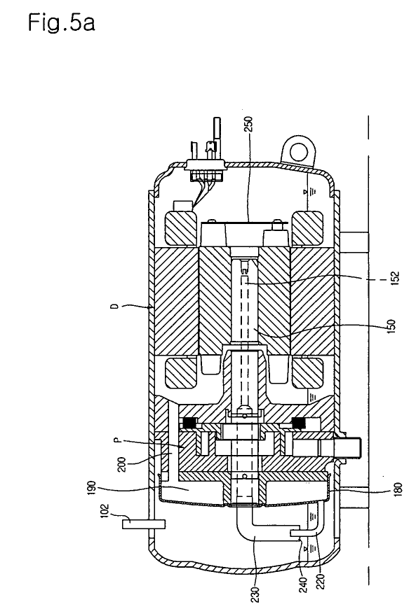

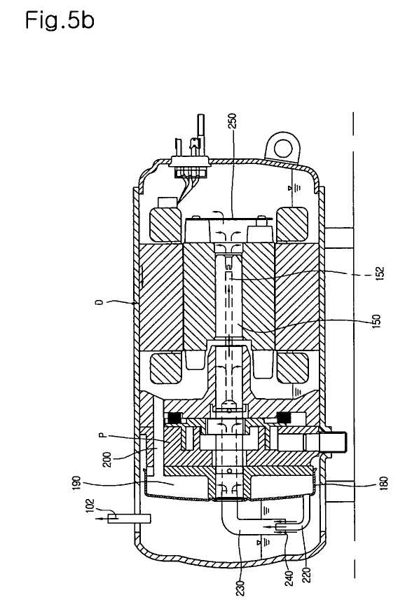

FIG. 5A is a longitudinal sectional view illustrating oil supply when the operation of the horizontal type orbiting vane compressor is stopped, and FIG. 5B is a longitudinal sectional view illustrating oil supply when the operation of the horizontal type orbiting vane compressor is initiated or resumed.

As shown in FIG. 5A, no compressed refrigerant gas is present in the discharge chamber 190 when the operation of the horizontal type orbiting vane compressor is stopped. As a result, the discharge pressure of the compressed refrigerant gas is not applied to the discharge pipe 220, and therefore, the level of oil in an oil sump 103 is not changed. Consequently, oil is not supplied to the oil hole 152 of the rotary shaft 150.

When the operation of the horizontal type orbiting vane compressor is initiated or resumed as shown in FIG. 5B, on the other hand, the rotary shaft 150 is rotated by the drive unit D, and therefore, the wrap 130a of the orbiting vane 130 performs an orbiting movement in the operation space 143 of the cylinder 140 to compress refrigerant gas introduced into the cylinder 140 through the inlet port 141.

The compressed high-pressure refrigerant gas is discharged into the discharge chamber 190 through inner and outer outlet ports (not shown) of the cylinder 140, and is then discharged into the shell 1 at the drive unit side through the discharge channel 200, which extends through the compression unit P.

Meanwhile, some of the high-pressure refrigerant gas is discharged out of the discharge chamber 190 through the discharge pipe 220 connected to the muffler 180. At this time, the pressure around the discharge side is decreased, and therefore, the pressure of the drive unit D becomes higher than that of the compression unit P. As a result, the level of oil in the oil sump 103 rises, and suction pressure is created at the oil inlet port 240 between the discharge pipe 220 and the oil tube 230. Consequently, oil is supplied to the oil hole 152 of the rotary shaft 150 through the oil tube 230.

Oil contained in the refrigerant gas discharged through the oil hole 152 of the rotary shaft 150 is dissolved in the refrigerant gas or separated from the refrigerant gas by the oil separating plate 250, which is disposed at the outlet side of the oil hole 152 of the rotary shaft 150.

As apparent from the above description, the present invention provides a horizontal type orbiting vane compressor that is capable of forming compression chambers at the inside and the outside of a wrap of an orbiting vane as the wrap performs an orbiting movement in an operation space defined in a cylinder. Consequently, the present invention has the effect of accomplishing miniaturization of an outdoor unit of an air conditioner when the horizontal type orbiting vane compressor is installed in the outdoor unit.

Furthermore, oil supply to the oil hole of the rotary shaft is performed using the discharge pressure of the high-pressure refrigerant gas compressed in the compression unit. Consequently, the present invention has the effect of accomplishing smooth and reliable oil supply. In addition, the structure of the horizontal type orbiting vane compressor is simplified, and the number of relevant parts is reduced. Consequently, the present invention has the effect of improving assembly efficiency of the horizontal type orbiting vane compressor and decreasing the manufacturing costs of the horizontal type orbiting vane compressor.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A horizontal type orbiting vane compressor comprising:
a horizontally disposed shell having an inlet tube and an outlet tube;
a compression unit disposed in the shell at one side of a horizontally disposed rotary shaft such that the compression unit is rotated by a drive unit for compressing refrigerant gas; and
an oil-supplying unit for supplying oil from an oil sump formed at the lower part of the shell to an oil hole extending through the rotary shaft by the discharge pressure of the compressed high-pressure refrigerant gas.

2. The compressor as set forth in claim 1, wherein the rotary shaft is disposed such that opposite ends of the rotary shaft are rotatably supported by a main bearing and a subsidiary bearing, which are disposed at opposite sides of the compression unit, respectively.

3. The compressor as set forth in claim 1, wherein the compression unit comprises:
a cylinder having an inlet port formed at one side thereof; and
a wrap of an orbiting vane for performing an orbiting movement in an operation space defined in the cylinder.

4. The compressor as set forth in claim 3, wherein the inlet port of the cylinder communicates with the inlet tube of the shell.

5. The compressor as set forth in claim 3, wherein the operation space is defined between an inner wall of the cylinder and an inner ring.

6. The compressor as set forth in claim 3, wherein the operation space is divided into inner and outer compression chambers by the wrap.

7. The compressor as set forth in claim 6, wherein the cylinder has a pair of outlet ports, which communicate with the inner and outer compression chambers, respectively.

8. The compressor as set forth in claim 7, further comprising:
a muffler disposed adjacent to the outlet ports of the cylinder; and
a discharge channel formed inside the muffler, the discharge channel extending though the compression unit.

9. The compressor as set forth in claim 8, wherein the oil-supplying unit comprises:
a discharge pipe having one end horizontally connected to the lower part of the muffler and the other end bent upward such that the upward-bent end is perpendicular to the end of the discharge pipe horizontally connected to the lower part of the muffler.

10. The compressor as set forth in claim 9, wherein the oil-supplying unit further comprises:
an oil tube having one end communicating with the oil hole, which horizontally extends through the rotary shaft, and the other end bent downward such that the downward-bent end is perpendicular to the end of the oil tube communicating with the oil hole,
the downward-bent end of the oil tube surrounding the upward-bent end of the discharge pipe.

11. The compressor as set forth in claim 10, wherein the oil-supplying unit further comprises:
an oil inlet port formed between the oil tube and the discharge pipe.

12. The compressor as set forth in claim 1, wherein the oil-supplying unit further comprises:
an oil separating plate disposed at the outlet side of the oil hole of the rotary shaft.

13. The compressor as set forth in claim 1, wherein the drive unit comprises:
a stator fixedly disposed in the shell; and
a rotor disposed in the stator for rotating the rotary shaft, which horizontally extends through the rotor, when electric current is supplied to the rotor.

14. An oil-supplying unit of a horizontal type orbiting vane compressor, comprising:
a discharge pipe having one end horizontally connected to the lower part of a muffler, which is disposed adjacent to outlet ports of a compression unit, and the other end bent upward such that the upward-bent end is perpendicular to the end of the discharge pipe horizontally connected to the lower part of the muffler; and
an oil tube having one end communicating with the oil hole, which horizontally extends through the rotary shaft, and the other end bent downward such that the downward-bent end is perpendicular to the end of the oil tube communicating with the oil hole, wherein
the downward-bent end of the oil tube surrounds the upward-bent end of the discharge pipe.

15. The oil-supplying unit as set forth in claim 14, further comprising:
an oil inlet port formed between the oil tube and the discharge pipe.

16. The oil-supplying unit as set forth in claim 14, further comprising:
an oil separating plate disposed at the outlet side of the oil hole of the rotary shaft.
